(19) United States
(12) Patent Application Publication
(10) Pub. No.: US 2005/0148266 A1
(43) Pub. Date: Jul. 7, 2005

(54) Self-supporting pleated electret filter media

(76) Inventors: David Lewis Myers, Cumming, GA (US); Ganesh C. Deka, Duluth, GA (US); Nina Cecilia Frazier, Marietta, GA (US)

Correspondence Address: KIMBERLY-CLARK WORLDWIDE, INC., 401 NORTH LAKE STREET, NEENAH, WI, 54956, US

(21) Appl. No.: 10/748,611

(22) Filed: Dec. 30, 2003

(51) Int. Cl. B32B 3/00; B32B 9/00; D04H 1/00; D04H 5/00; D04H 13/00; D04H 3/16

(52) U.S. Cl. 442/401; 442/327; 442/59; 442/154; 442/361; 442/362; 442/363; 442/364

(57) ABSTRACT

The present invention provides an electret nonwoven web useable in a variety of applications. The nonwoven web is prepared from continuous fibers and once formed, a binder composition is applied to the nonwoven web. Generally the binder composition is sprayed on or impregnated into the nonwoven web and the binder composition is cured forming a nonwoven web/binder composite material. After the binder composition is cured, the composite is electret charged. The application of the binder composition to the nonwoven web provides the nonwoven web with stiffness and with characteristics such that it can be pleated and such pleats can be retained without the use of a supporting substrate. This makes the electret charged nonwoven web highly suitable and cost effective for filter media by eliminating the need for laminating the media to a supporting member.

### FIELD OF THE INVENTION

The present invention is related to an electret charged nonwoven web which is highly suitable as a filter media for filtering gaseous streams, such as air streams.

### BACKGROUND OF THE INVENTION

Many different types of nonwoven webs have been used as filter media for various filtration applications. Nonwoven webs which have been used as filtration media include, for example, meltblown fiber webs, solution spun fiber webs, wet-laid fiber webs, carded fiber webs, air-laid fiber webs and spunbond fiber webs. In selecting a nonwoven for a filter application, factors such as efficiency and permeability must be considered.

Of these nonwoven fiber webs, meltblown fiber webs have been widely used as fine particle filtration media, since the fibers are densely packed and are relatively fine fibers which provide fine interfiber pore structures. These fine interfiber pore structures are highly suitable for mechanically trapping or screening fine particles, thereby providing a high filter efficiency. However, the fine pore structure of meltblown fiber webs and other similar webs having densely packed fine fibers results in a low permeability, creating a high pressure drop across the webs. Consequently, the low permeability of fine fiber filter media requires the application of a high driving pressure to establish an adequate throughput rate across the filter media. Furthermore, as contaminants accumulate on the surface of the filter media, the contaminants tend to clog the small interfiber pores, further reducing the permeability of the media, thereby increasing the pressure drop across the media and rapidly shortening service-life of the filter media.

In contrast, filter media with large interfiber pores typically have fibers which are usually sparsely packed and which are relatively thick. Nonwoven webs of this type, generally have a high permeability, thus requiring a relatively low driving pressure to provide an adequate throughput rate and an extended service-life. However, highly permeable filter media suffer from a low filter efficiency in that the large interfiber pore structures of the media do not provide interstitial configurations that are suitable for entrapping fine contaminant particles.

Currently, heating, venting and air conditioning (HVAC) filters are produced using polyester or polypropylene filter media that require the support of an expanded metal backing. The expanded metal, when adhered to the nonwoven filter, helps in the retention of pleats following the mechanical deformation of the pleating process. Typically, the pleating process is done at room temperature. Nonwoven filter media are typically pliable, soft and will not retain a pleated form without the expanded metal backing. The disadvantages of using expanded metal are: 1) short roll lengths, which require frequent changes and line down time; 2) sharp edges; 3) a separate lamination step; and 4) additional cost. One way to simplify the filter pleating process is to produce a filter medium that has a self-supporting pleat or that can be pleated without the use of expanded metal.

Currently, there are some self-supporting filter media commercially available. These media are formed from polyester staple fibers having a denier in the 3.0 to about 6.0 dpf range. In addition, these polyester staple fiber media are resin bonded. The large fiber size of polyester staple fiber media offer low filtration efficiency performance.

Through-air bonded bicomponent spunbond filter media, such as those described in U.S. Pat. No. 6,169,045 to Pike et al., have been found to be very effective in filtering particles from gaseous streams. However, the media of this patent has an inherently low stiffness which requires a support in order to hold a pleat. Therefore, the material of this patent must be used in conjunction with expanded metal to form a pleated material.

There remains a need for economical pleated filter media that provide a highly desirable combination of high filtration efficiency, low pressure drop, high capacity and high physical strength without needing to be laminated to a support material in order to maintain the pleat. Stated another way, there is a need for self-supporting filter media that provide combinations of desirable filtration properties, including high filtration efficiency, high permeability, low pressure drop, high throughput, long service-life and self-supporting strength.

### SUMMARY OF THE INVENTION

The present invention provides an electret nonwoven web useable in a variety of applications. The nonwoven web is prepared from continuous fibers and once formed, a binder composition is applied to the nonwoven web. Generally the binder composition is sprayed on or impregnated into the nonwoven web and the binder composition is cured forming a nonwoven web/binder composite material. After the binder composition is cured, the composite is electret charged. The application of the binder composition to the nonwoven web provides the nonwoven web with stiffness and with characteristics such that it can be pleated and such pleats can be retained without the use of a supporting substrate. This makes the electret charged nonwoven web highly suitable and cost effective for filter media by eliminating the need for laminating the media to a supporting member.

The present invention also provides a method of forming the electret nonwoven web and corresponding pleated filter media. In the process of the present invention, a nonwoven web of continuous fibers is provided. Next a resin composition is applied to the nonwoven web and then cured, removing any solvent used to apply the binder to the nonwoven web, thereby forming a nonwoven web/binder composite. Once cured, the nonwoven web/binder composite is electret charged. When used as a filter media, it is further desirable to pleat the nonwoven web.

### BRIEF DESCRIPTION OF DRAWINGS

FIG. 1 shows an exemplary process for producing a nonwoven web useful in the present invention.

FIG. 2 shows an exemplary method of imparting an electret treatment to the nonwoven web.

### DEFINITIONS

As used herein, the term “comprising” is inclusive or open-ended and does not exclude additional unrecited elements, compositional components, or method steps.

As used herein, the term “polymer” generally includes, but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic and random symmetries.

As used herein, the term “fiber” includes both staple fibers, i.e., fibers which have a defined length between about 19 mm and about 60 mm, fibers longer than staple fiber but are not continuous, and continuous fibers, which are sometimes called “substantially continuous filaments” or simply “filaments”. The method in which the fiber is prepared will determine if the fiber is a staple fiber or a continuous filament.

As used herein, the term “nonwoven web” means a web having a structure of individual fibers or threads which are interlaid, but not in an identifiable manner as in a knitted web. Nonwoven webs have been formed from many processes, such as, for example, meltblowing processes, spunbonding processes, air-laying processes, coforming processes and bonded carded web processes. The basis weight of nonwoven webs is usually expressed in ounces of material per square yard (osy) or grams per square meter (gsm) and the fiber diameters are usually expressed in microns, or in the case of staple fibers, denier. It is noted that to convert from osy to gsm, multiply osy by 33.91.

As used herein, the term “spunbond fibers” refers to small diameter fibers of a drawn polymeric material. Spunbond fibers may be formed by extruding molten thermoplastic material as filaments from a plurality of fine, usually circular capillaries of a spinneret with the diameter of the extruded filaments then being rapidly reduced as in, for example, U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, U.S. Pat. No. 3,542,615 to Dobo et al, and U.S. Pat. No. 5,382,400 to Pike et al., each herein incorporated by reference. Spunbond fibers are generally not tacky when they are deposited onto a collecting surface and are generally continuous. Spunbond fibers are often about 10 microns or greater in diameter. However, fine fiber spunbond webs (having an average fiber diameter less than about 10 microns) may be achieved by various methods including, but not limited to, those described in commonly assigned U.S. Pat. No. 6,200,669 to Marmon et al. and U.S. Pat. No. 5,759,926 to Pike et al., each is hereby incorporated by reference in its entirety.

As used herein, the term “meltblown fibers” means fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin, which is hereby incorporated by reference in its entirety. Meltblown fibers are microfibers, which may be continuous or discontinuous, and are generally smaller than 10 microns in average diameter The term “meltblown” is also intended to cover other processes in which a high velocity gas, (usually air) is used to aid in the formation of the filaments, such as melt spraying or centrifugal spinning.

As used herein, the term “bonded carded web” refers to webs that are made from staple fibers which are sent through a combing or carding unit, which separates or breaks apart and aligns the staple fibers in the machine direction to form a generally machine direction-oriented fibrous nonwoven web. Such fibers are usually purchased in bales which are placed in an opener/blender or picker which separates the fibers prior to the carding unit. Once the web is formed, it then is bonded by one or more of several known bonding methods. One such bonding method is powder bonding, wherein a powdered adhesive is distributed through the web and then activated, usually by heating the web and adhesive with hot air. Another suitable bonding method is pattern bonding, wherein heated calender rolls or ultrasonic bonding equipment are used to bond the fibers together, usually in a localized bond pattern, though the web can be bonded across its entire surface if so desired. Another suitable and well-known bonding method, particularly when using bicomponent staple fibers, is through-air bonding.

As used herein, the term “airlaying” or “airlaid” is a well known process by which a fibrous nonwoven layer can be formed. In the airlaying process, bundles of small fibers having typical lengths ranging from about 3 to about 19 millimeters (mm) are separated and entrained in an air supply and then deposited onto a forming screen, usually with the assistance of a vacuum supply. The randomly deposited fibers then are bonded to one another using, for example, hot air or a spray adhesive.

As used herein, the term “multicomponent fibers” refers to fibers or filaments which have been formed from at least two polymers extruded from separate extruders but spun together to form one fiber. Multicomponent fibers are also sometimes referred to as “conjugate” or “bicomponent” fibers or filaments. The term “bicomponent” means that there are two polymeric components making up the fibers. The polymers are usually different from each other, although conjugate fibers may be prepared from the same polymer, if the polymer in each component is different from one another in some physical property, such as, for example, melting point or the softening point. In all cases, the polymers are arranged in substantially constantly positioned distinct zones across the cross-section of the multicomponent fibers or filaments and extend continuously along the length of the multicomponent fibers or filaments. The configuration of such a multicomponent fiber may be, for example, a sheath/core arrangement, wherein one polymer is surrounded by another, a side-by-side arrangement, a pie arrangement or an “islands-in-the-sea” arrangement. Multicomponent fibers are taught in U.S. Pat. No. 5,108,820 to Kaneko et al.; U.S. Pat. No. 5,336,552 to Strack et al.; and U.S. Pat. No. 5,382,400 to Pike et al.; the entire content of each is incorporated herein by reference. For two component fibers or filaments, the polymers may be present in ratios of 75/25, 50/50, 25/75 or any other desired ratios.

As used herein, the term “multiconstituent fibers” refers to fibers which have been formed from at least two polymers extruded from the same extruder as a blend or mixture. Multiconstituent fibers do not have the various polymer components arranged in relatively - constantly positioned distinct zones across the cross-sectional area of the fiber and the various polymers are usually not continuous along the entire length of the fiber, instead usually forming fibrils or protofibrils which start and end at random. Fibers of this general type are discussed in, for example, U.S. Pat. Nos. 5,108,827 and 5,294,482 to Gessner.

As used herein, through-air bonding or “TAB” means a process of bonding a nonwoven fiber web in which air, which is sufficiently hot to melt one of the polymers of which the fibers of the web are made, is forced through the web. The air velocity is between 100 and 500 feet per minute and the dwell time may be as long as 10 seconds. The melting and re-solidification of the polymer provides the bonding. Through-air bonding has relatively restricted variability and since through-air bonding requires the melting of at least one component to accomplish bonding, it is generally restricted to webs with two components like conjugate fibers or those which include an adhesive. In the through-air bonder, air having a temperature above the melting temperature of one component and below the melting temperature of another component is directed from a surrounding hood, through the web, and into a perforated roller supporting the web. Alternatively, the through-air bonder may be a flat arrangement wherein the air is directed vertically downward onto the web. The operating conditions of the two configurations are similar, the primary difference being the geometry of the web during bonding. The hot air melts the lower melting polymer component and thereby forms bonds between the filaments to integrate the web.

As used herein, the term “pattern bonded” refers to a process of bonding a nonwoven web in a pattern by the application of heat and pressure or other methods, such as ultrasonic bonding. Thermal pattern bonding typically is carried out at a temperature in a range of from about 80° C. to about 180° C. and a pressure in a range of from about 150 to about 1,000 pounds per linear inch (59-178 kg/cm). The pattern employed typically will have from about 10 to about 250 bonds/inch² (1-40 bonds/cm²) covering from about 5 to about 30 percent of the surface area. Such pattern bonding is accomplished in accordance with known procedures. See, for example, U.S. Design Pat. No. 239,566 to Vogt, U.S. Design Pat. No. 264,512 to Rogers, U.S. Pat. No. 3,855,046 to Hansen et al., and U.S. Pat. No. 4,493,868, supra, for illustrations of bonding patterns and a discussion of bonding procedures, which patents are incorporated herein by reference. Ultrasonic bonding is performed, for example, by passing the multilayer nonwoven web laminate between a sonic horn and anvil roll as illustrated in U.S. Pat. No. 4,374,888 to Bornslaeger, which is hereby incorporated by reference in its entirety.

As used herein the term “denier” refers to a commonly used expression of fiber thickness which is defined as grams per 9000 meters. A lower denier indicates a finer fiber and a higher denier indicates a thicker or heavier fiber. Denier can be converted to the international measurement “dtex”, which is defined as grams per 10,000 meters, by dividing denier by 0.9.

As used herein, the term “self-supporting pleat” means that the material can be pleated and hold the pleat without the use of a stiffening member, such as expanded metal described above.

Description of the Test Methods

Air Filtration Measurements: The air filtration efficiencies of the substrates discussed below were evaluated using a TSI, Inc. (St. Paul, Minn.) Model 8110 Automated Filter Tester (AFT). The Model 8110 AFT measures pressure drop and particle filtration characteristics for air filtration media. The AFT utilizes a compressed air nebulizer to generate a submicron aerosol of sodium chloride particles which serves as the challenge aerosol for measuring filter performance. The characteristic size of the particles used in these measurements was 0.3 micrometer. Typical airflow rates were between 31, liters per minute and 33 liters per minute. The AFT test was performed on a sample area of about 140 cm². The performance or efficiency of a filter medium is expressed as the percentage of sodium chloride particles that penetrate the filter. Penetration is defined as transmission of a particle through the filter medium. The transmitted particles were detected downstream from the filter. The percent penetration (% P) reflects the ratio of the downstream particle count to the upstream particle count. Light scattering was used for the detection and counting of the sodium chloride particles. The percent efficiency (ε) may be calculated from the percent penetration according to the formula: ε=100−% P.

Detailed Description of the Invention

The present invention provides a electret charged nonwoven web. The nonwoven web is prepared from continuous fibers and has a binder composition applied thereto. Typically, the binder composition is sprayed on or impregnated into the nonwoven web. After application of the binder composition to the nonwoven web, the binder composition is cured, removing any carrier present in the binder composition, thereby forming a nonwoven web/binder composite. It has been discovered that nonwoven web with the binder composition applied thereto can be pleated and the pleats are a self-supporting pleats, i.e. wherein the material holds the pleat without the use of a stiffening member. Surprisingly, it has been discovered that the nonwoven web/binder composite can be electret charged, which results in a filter media having a high filtration efficiency.

The fibers of the nonwoven web may be monocomponent, multicomponent or multiconstituent fibers. Mixtures of these types of fibers may also be used. Of these types of fibers, it is generally preferred that the fibers contain multicomponent fibers, especially in applications where lofty nonwoven webs are desired. In addition, the fibers may be crimped or uncrimped. Further, the fibers of the nonwoven web of the present invention can be made from thermoplastic polymers.

Suitable thermoplastic polymers useful in preparing the thermoplastic fibers of the nonwoven web of the present invention include polyolefins, polycarbonates, polyvinylchloride, polytetrafluoroethylene, perfluoroethylene propylene copolymers, polystyrene, and copolymers and blends thereof. Suitable polyolefins include polyethylene, e.g., high density polyethylene, medium density polyethylene, low density polyethylene and linear low density polyethylene; polypropylene, e.g., isotactic polypropylene, syndiotactic polypropylene, blends of isotactic polypropylene and atactic polypropylene, and blends thereof; polybutylene, e.g., poly(1-butene) and poly(2-butene); polypentene, e.g., poly(1-pentene) and poly(2-pentene); poly(3-methyl-1-pentene); poly(4-methyl 1-pentene); and copolymers and blends thereof. Suitable copolymers include random and block copolymers prepared from two or more different unsaturated olefin monomers, such as ethylene/propylene and ethylene/butylene copolymers. An example of a polycarbonate usable in the present invention is bis-phenol-A polycarbonate.

Many polyolefins are available for fiber production, for example polyethylenes such as Dow Chemical's ASPUN 681 1A linear low-density polyethylene, 2553 LLDPE and 25355 and 12350 high density polyethylene are such suitable polymers. The polyethylenes have melt flow rates in g/10 min at 190° F. and a load of 2.16 kg, of about 26, 40, 25 and 12, respectively. Fiber forming polypropylenes include, for example, Basell's PF-01 5 polypropylene. Many other polyolefins are commercially available and generally can be used in the present invention. The particularly preferred polyolefins are polypropylene and polyethylene.

When used as a filter medium, the fibers particularly suitable for the filter medium include crimped and uncrimped spunbond fibers. As stated above, these fibers can be monocomponent fibers or multicomponent conjugate fibers. Suitable spunbond fibers for the present invention have an average diameter of about 1 μm to about 100 μm, and in particular, between about 10 μm to about 50 μm. Of the crimped and uncrimped spunbond fibers, crimped fibers are particularly suitable fibers for the present invention. Crimped multicomponent fibers are fibers that contain two or more component polymers, and more particularly suitable fibers are multicomponent conjugate fibers containing polymers of different melting points. Preferably, the melting point difference between the highest melting polymer and the lowest melting polymer of the conjugate fibers should be at least about 5° C., more preferably about 30° C., so that the lowest melting polymer can be melted without affecting the chemical and physical integrities of the highest melting polymer.

The preferred nonwoven web for filter applications is through-air bonded nonwoven webs fabricated from crimped multicomponent conjugate fibers, and more particularly suitable conjugate fibers are spunbond conjugate fibers. For illustrative purposes, the present invention hereinafter is directed to bicomponent spunbond conjugate fibers (hereinafter referred to as bicomponent fibers) and bicomponent fiber webs, and to a through-air bonding process although other spunbond conjugate fibers of more than two polymers and other bonding processes can be utilized for the present invention, as discussed above.

In accordance with the present invention, the suitable bicomponent fibers have the low melting component polymer at least partially exposed to the surface along the entire length of the fibers. Suitable configurations for the bicomponent fibers include side-by-side configurations and sheath-core configurations, and suitable sheath-core configurations include eccentric sheath-core, islands-in-the-sea configurations and concentric sheath-core configurations. Of these sheath-core configurations, eccentric sheath-core configurations are particularly useful since imparting crimps on eccentric sheath-core bicomponent fibers can be effected more easily. If a sheath-core configuration is employed, it is highly desired to have the low melting polymer form the sheath.

The multicomponent fibers have from about 20% to about 80%, preferably from about 40% to about 60%, by weight of the low melting polymer and from about 80% to about 20%, preferably about 60% to about 40%, by weight of the high melting polymer.

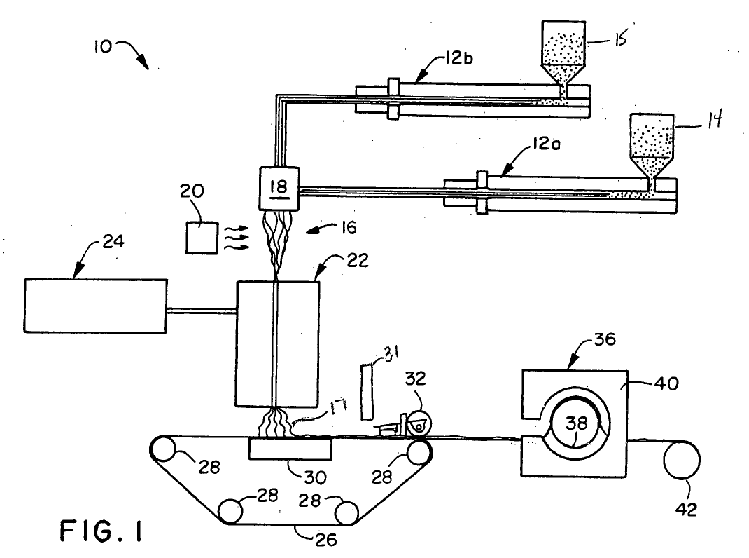

To illustrate the process of the present invention using the multicomponent spunbond fiber nonwoven web, attention is directed to FIG. 1. In FIG. 1, the process line 10 includes a pair of extruders 12a and 12b for separately supplying extruded polymer components, a high melting polymer and a low melting polymer, to a bicomponent spinneret 18. Hoppers 14 and 15 supply the polymer to the extruders 12a and 12b, respectively. Spinnerets for producing bicomponent fibers are well known in the art and thus are not described herein. In general, the spinneret 18 includes a housing containing a spin pack which includes a plurality of plates having a pattern of openings arranged to create flow paths for directing the high melting and low melting polymers to each fiber-forming opening in the spinneret. The spinneret 18 has openings arranged in one or more rows, and the openings form a downwardly extending curtain of fibers when the polymers are extruded through the spinneret.

The line 10 further includes a quenching gas outlet 20 adjacently positioned to the curtain of fibers 16 extending from the spinneret 18, and the gas from the outlet 20 at least partially quenches, i.e., the polymer forming the fibers is no longer able to freely flow, and develops a latent helical crimp in the extending fibers 16. As an example, an air stream of a temperature between about 45° F. (7.2° C.) and about 90° F. (32° C.) which is directed substantially perpendicular to the length of the fibers at a velocity from about 100 to about 400 feet per minute can be effectively used as a quenching gas. Although the quenching process is illustrated with a one-outlet quenching system, more than one quenching gas outlets can be utilized.

A fiber draw unit or an aspirator 22 is positioned below the quenching gas outlet and receives the quenched fibers. Fiber draw units or aspirators for use in melt spinning polymers are well known in the art, and exemplary fiber draw units suitable for the present invention include a linear fiber aspirator of the type shown in U.S. Pat. No. 3,802,817 to Matsuki et al. and eductive guns of the type shown in U.S. Pat. No. 3,692,618 to Dorshner et al. and U.S. Pat. No. 3,423,266 to Davies et al.

The fiber draw unit 22, in general, has an elongated passage through which the fibers are drawn by aspirating gas. The aspirating gas may be any gas, such as air, that does not adversely interact with the polymer of the fibers. The aspirating gas may be heated above room temperature, at room temperature or below room temperature. The actual temperature of the aspirating gas is not critical to the present invention. By way of an example, the aspirating gas may be heated using a temperature adjustable heater 24. It is noted, however, that the aspirating gas does not have to be heated in the present invention.

If the aspirating gas in heated, the aspirating gas draws the quenched fibers and heats the fibers to a temperature that is required to activate the latent crimp thereon. The temperature required to activate the latent crimp on the fibers ranges from about 1 10° F. (43.3° C.) to a maximum temperature which is slightly above the melting point of the low melting component polymer. Generally, a higher air temperature produces a higher number of crimps. One of the important advantages of this fiber web forming process is that the crimp density, i.e., the number of crimps per unit length of a fiber, of the fibers and thus the density and pore size distribution of the resulting webs can be controlled by controlling the temperature of the aspirating gas, providing a convenient way to engineer nonwoven webs to accommodate different needs of different applications. Additionally, the crimp density can be controlled to some degree by regulating the amount of potential latent crimps that can be heat activated, and the amount of potential latent crimps can be controlled by varying the spinning conditions, such as melt temperature and aspirating gas velocity. For example, higher amounts of potential latent crimps can be imparted on polyethylene/ polypropylene bicomponent fibers by supplying lower velocities of aspirating gas.

If the aspirating air is unheated or below room temperature, the heater 24 acts as a blower and supplies aspirating air to the fiber draw unit 22. The aspirating air draws the filaments and ambient air through the fiber draw unit. The aspirating air in the formation of the post formation crimped filaments is unheated and is at or about ambient temperature. The ambient temperature may vary depending on the conditions surrounding the apparatus used in the process of FIG. 1. Generally, the ambient air is in the range of about 65° F. (18 ° C.) to about 85° F. (29.4° C.); however, the temperature may be slightly above or below this range. If the fibers are drawn with ambient temperature or below, the crimp of the fibers can be activated by heating the fibers briefly, such as with a hot air knife (“HAK”) 31, prior to bonding. The activation of the crimp in the post formation process will be described in more detail below.

The drawn fibers 17 are then deposited onto a continuous forming surface 26 and the drawn fibers are deposited onto the liner in a random manner. The forming surface 26 is moved around rollers 28, of which one or more may be powered by a motor (not shown). The fiber depositing process preferably is assisted by a vacuum device 30 placed underneath the forming surface. The vacuum force largely eliminates the undesirable scattering of the fibers and guides the fibers onto the forming surface to form a uniform unbonded web of continuous fibers. The resulting web can be optionally lightly compressed by a compression roller 32, if a light compaction of the web is desired to provide enhanced integrity to the unbonded web before the web is subjected to a bonding process. Generally, compression of the web should be avoided if a lofty structure is desired. Optionally, a second bank of the fiber forming and drawing apparatus can be added to the process of FIG. 1, which will allow for the formation of a layered product.

If the fibers do not have the crimp activated, then the filaments of the nonwoven web are then optionally heated by traversal under one of a hot air knife (HAK) or hot air diffuser 31. Generally, it is preferred that the filaments of the nonwoven web are heat treated. A conventional hot air knife includes a mandrel with a slot that blows a jet of hot air onto the nonwoven web surface. Such hot air knives are taught, for example, by U.S. Pat. No. 5,707,468 to Arnold, et al. A hot air diffuser is an alternative to the HAK which operates in a similar manner but with lower air velocity over a greater surface area and thus uses correspondingly lower air temperatures. Depending on the conditions of the hot air diffuser or hot air knife (temperature and air flow rate) the filaments may receive an external skin melting or a small degree of bonding during this traversal through the first heating zone. This bonding is usually only sufficient only to hold the filaments in place during further processing; but light enough so as to not hold the fibers together when they need to be manipulated manually. Compaction of the nonwoven web should be avoided as much as possible. Such bonding may be incidental or eliminated altogether, if desired.

The unbonded web is then bonded in a bonder, such as a through-air bonder 36, to provide coherency and physical strength. The use of a through-air bonder is particularly useful for the present invention in that the bonder produces a highly bonded nonwoven web without applying significant compacting pressure. In the through-air bonder 36, a flow of heated air is applied through the web, e.g., from a hood 40 to a perforated roller 38, to heat the web to a temperature above the melting point of the low melting component polymer but below the melting point of the high melting component polymer. The bonding process may be assisted by a vacuum device that is placed underneath the perforated roller 38. Upon heating, the low melting polymer portions of the web fibers are melted and the melted portions of the fibers adhere to adjacent fibers at the cross-over points while the high melting polymer portions of the fibers tend to maintain the physical and dimensional integrity of the web. As such, the through-air bonding process turns the unbonded web into a cohesive nonwoven fiber web without significantly changing its originally engineered web dimensions, density, porosity and crimp density.

The bonding air temperature may vary widely to accommodate different melting points of different component polymers and to accommodate the temperature and speed limitations of different bonders. In addition, basis weight of the web must be considered in choosing the air temperature. It is to be noted that the duration of the bonding process should not be too long if it is desired to avoid significant shrinkage of the web. As an example, when polypropylene and polyethylene are used as the component polymers for a conjugate-fiber web, the air flowing through the through-air bonder may have a temperature between about 230° F. (110° C.) and about 280° F. (138° C.) and a velocity from about 100 to about 500 feet per minute.

The above-described through-air bonding process is a highly suitable bonding process that can be used not only to effect high strength interfiber bonds without significantly compacting the webs, but also to impart a density gradient across the depth of the webs, if desired. The density gradient imparted filter media that are produced with the through-air bonding process have the highest fiber density at the region where the fibers contact the web supporting surface, e.g., the perforated roller 38. Although it is not wished to be bound by any theory, it is believed that during the through-air bonding process, the fibers across the depth of the web toward the web supporting surface are subjected to increasing compacting pressures of the web's own weight and of the flows of the assist vacuum and the bonding air, and, thus, a desirable fiber density gradient may be imparted in the resulting web when proper settings in the bonder are employed.

Once bonded in the through-air bonder, the nonwoven web 42 may have the resin applied thereto and electret charged-in line (not shown), or be wound onto a roll and later treated.

The filter medium produced in accordance with the present invention is a lofty, low density medium that can retain a large quantity of contaminants without impeding the filtrate flow or causing a high pressure drop across the filter medium. The highly porous, three-dimensional loft of the present filter medium promotes the mechanical entrapment of contaminants within its interstitial spaces, while providing alternate channels for the filtrate to flow through. In addition, the filter medium may contain a density gradient of fibers across its depth, adding to the advantages of the present filter medium. As stated above, a fiber density gradient in filter media improves the filter efficiency and service life.

In another aspect of the present invention, a higher density nonwoven web may be prepared from fibers which are uncrimped when deposited on the forming surface and do not possess any latent crimp. Such fibers may be prepared from symmetrical conjugate fiber configuration, such as a sheath core fiber configuration. Other conjugate fiber configurations can be used in forming the higher density nonwoven webs by changing the process described for FIG. 1, such as reducing the polymer through-put rate and increasing the fiber drawing force. Such nonwoven webs are described in U.S. Pat. No. 5,855,784, which is hereby incorporated by reference.

Alternatively, a filter medium containing a fiber density gradient can be produced by laminating two or more layers of filter media having different fiber densities or by using two or more banks of the fiber forming and drawing apparatus described in FIG. 1. Such a filter media of different fiber densities can be prepared, for example, by imparting different levels of crimps on the fibers or utilizing fibers of different crimp levels and/or different sizes. More conveniently, if a spunbond process is used to produce the present filter medium, a fiber density gradient can be imparted by sequentially spinning fibers of different crimp levels and/or different fiber sizes and sequentially depositing the fibers onto a forming surface.

Commercially available nonwoven materials usable in the present invention include the INREPID 353H, 355H, 358H and 411 H available from Kimberly-Clark Global Sales, Roswell Ga, 30076.

Once formed, a binder composition is applied to the nonwoven web. The binder resins applied to nonwoven web include resins which have a relatively low curing temperature or self-crosslinking property. Exemplary binder compositions contain at least one binder resin including thermosetting resins such as acrylic resins, phenolic resins, ethylene-vinyl acetate resins and the like. Examples of acrylic resins include, for example, 2-hydroxyethyl acrylate, hydroxypropyl acrylate, ethylacrylate-itaconic acid-methyl methacrylate copolymer. One particularly preferred acrylic resin is commercially available from Rohm & Haas Co. under the tradename RHOPLEX TR-407. The resin may be in the applied form an emulsion or dispersion and is subsequently cured following the removal of the aqueous medium.

Modified acrylic latex emulsions may also be used. The addition of additives, such as polyurethanes or melamine-formaldehyde resins can further improve the pleatablity of the resin coated nonwoven web. Other monomers, such as styrene may be copolymerized with the acrylate in the binder in order to toughen the binder resin. One such commercially available is from the Rohm & Haas Co as RHOPLEX GL-730. It is believed that the Rohm & Haas polymer RHOPLEX GL-730 is a copolymer of styrene and an acrylic ester. Other additives, including non-crosslinking acrylic latexes may be added to the crosslinking acrylic latex. An exemplary non-crosslinking acrylic latex usable in this invention includes RHOPLEX AC-3001.

It is preferred that binder resin impregnates the nonwoven web. Any conventional resin coating technique may be used, such as knife coating, spraying, dipping and the like, so long as the nonwoven web is impregnated. Preferably, the resin is impregnated into the nonwoven web using a spraying process. In order to improve the wettability of the nonwoven web, and thus the ability of the resin dispersion or emulsion to impregnate or to form a discontinuous film on the nonwoven web, an external wetting agent may be applied to the nonwoven or an internal wetting agent may be added to the polymer used to prepare the fibers of the nonwoven web, as described above. Exemplary external wetting agents include, for example, applied surfactant treatments. Useful surfactants may be selected from, for example, anionic surfactants and cationic surfactants. As an example, dioctylester of sodium sulfosuccinic may be used. Disclosure of external wetting agents may be found in, for example, U.S. Pat. Nos. 4,426,417; 4,298,649 and 5,057,361; the contents of which are incorporated herein by reference.

Alternatively and/or additionally, the nonwoven web may be rendered hydrophilic by a surface modification technique such as, for example, corona discharge treatments, chemical etches, coatings, and the like.

Although not wishing to be bound by theory, it is believed that the ability to form a pleat is determined in large part by the stress-strain behavior of the material at small strains. In order for a pleat to form and be retained by a structure, the stress induced in the material must exceed the yield stress of the material leading to a permanent deformation. It is believed that the resin binder systems used in manufacturing the self-supporting filtration media increases the number of bond points in the structure by partially or completely encapsulating the fibers in the cured resin. Desirably, the binder forms discrete islands in the regions of the fiber crossing and bond points. After resin curing is completed, the bending strain induced by the pleating process is sufficient to exceed the yield stress of the cross-linked resin phase thereby fixing the encapsulated fibers in the pleated configuration. In the present invention, the nonwoven/resin binder composite exhibits a yield stress at strains of less than 10% in a bending mode such that the bent or folded composite exhibit little or no plastic recovery. Desirably, the composite exhibits a yield stress as strains less than 7%, and more desirably less than 5%.

The dry add-on for the binder resin is generally in the range of about 10% to about 70%, based on the weight of the binder treated nonwoven web. That is, if the nonwoven web with the cured binder applied weighs 100 grams, and the binder dry add-on is 50%, the 50 grams of the treated nonwoven web is from the nonwoven web and 50 grams is from the binder. Desirably, the add-on for the resin is in the 25 to 60% by weight range.

In accordance with the present invention, the nonwoven web with the resin applied thereto is electret charged. Electret charging or treating processes suitable for the present invention are known in the art. These methods include thermal, plasma-contact, electron beam and corona discharge methods. For example, U.S. Pat. No. 4,375,718 to Wadsworth et al., 5,401,446 to Tsai et al. and U.S. Pat. No. 6,365,088B1 to Knight et. al., each incorporated by reference disclose electret charging processes for nonwoven webs.

Each side of the nonwoven web can be conveniently electret charged by sequentially subjecting the web to a series of electric fields such that adjacent electric fields have substantially opposite polarities with respect to each other. For example, one side of web is initially subjected to a positive charge while the other side is subjected to a negative charge, and then the first side of the web is subjected to a negative charge and the other side of the web is subjected to a positive charge, imparting permanent electrostatic charges in the web. A suitable apparatus for electret charging the nonwoven web is illustrated in FIG. 2. An electret charging apparatus 50 receives a nonwoven web 42 having a first side 52 and a second side 54. The web 42 passes into the apparatus 50 with the second side 54 in contact with guiding roller 56. Then the first side 52 of the web comes in contact with a first charging drum 58 which rotates with the web 42 and brings the web 42 into a position between the first charging drum 58 having a negative electrical potential and a first charging electrode 60 having a positive electrical potential. As the web 42 passes between the charging electrode 60 and the charging drum 58, electrostatic charges are developed in the web 42. A relative positive charge is developed in the first side and a relative negative charge is developed in the second side. The web 42 is then passed between a negatively charged second drum 72 and a positively charged second electrode 64, reversing the polarities of the electrostatic charge previously imparted in the web and permanently imparting the newly developed electrostatic charge in the web. The electret charged web 65 is then passed on to another guiding roller 66 and removed from the electret charging apparatus 50. It is to be noted that for discussion purposes, the charging drums are illustrated to have negative electrical potentials and the charging electrodes are illustrated to have positive electrical potentials. However, the polarities of the drums and the electrodes can be reversed and the negative potential can be replaced with ground. In accordance with the present invention, the charging potentials useful for electret forming processes may vary with the field geometry of the electret process. For example, the electric fields for the above-described electret charging process can be effectively operated between about 1 KVDC/cm and about 30 KVDC/cm, desirably between about 4 KVDC/cm and about 20 KVDC/cm, and still more particularly about 7 kVDC/cm to about 12 kVDC/cm. when the gap between the drum and the electrodes is between about 1.2 cm and about 5 cm. The above-described suitable electret charging process is further disclosed in above-mentioned U.S. Pat. No. 5,401,446, which in its entirety is herein incorporated by reference

Electret charge stability can be further enhanced by grafting polar end groups onto the polymers of the multicomponent fibers. In addition, barium titanate and other polar materials may be blended with the polymers to enhance the electret treatment. Suitable blends are described in U.S. Pat. No. 6,162,535 to Turkevich et al, assigned to the assignee of this invention and in U.S. Pat. No. 6,573,205B1 to Myers et al, hereby incorporated by reference.

Other methods of electret treatment are known in the art such as that described in U.S. Pat. No. 4,375,718 to Wadsworth, U.S. Pat. No. 4,592,815 to Nakao and U.S. Pat. No. 4,874,659 to Ando, each hereby incorporated in its entirety by reference.

Surprisingly, it was discovered that the resin treated nonwoven web can be electret charged and that the electret charge is stable on the resin treated or impregnated nonwoven web. It is believed that the ability of the impregnated nonwoven web to accept electret charge is due in part to the discontinuous nature of the resin treatment. Rather than forming a continuous film coating of the filaments, the binder resin exists as discrete islands predominantly located at fiber crossings and bond points. Thus, a significant percentage of the original surface area of the filter is not modified and can readily accept and retain electrical charge.

The basis weight of the nonwoven web may vary widely. However, when used as a filter media, particularly suitable basis weights are from about 10 gsm to about 500 gsm, more particularly from about 14 gsm to about 450 gsm, and most particularly from about 15 gsm to about 340 gsm.

### EXAMPLES

### Example 1

A binder composition with 20% TR 407+80% GL 730 (described above) was applied to a 3.25 osy high loft spunbond filter media, prepared in accordance with U.S. Pat. No. 6,169,045, using dip and squeeze application. The binder add-on was about 50% by weight. The media has the following physical properties shown in Table 1:

TABLE 1

| | Air | Gurley Stiffness | | | |
|---|---|---|---|---|---|
| | Permeability | Left | Right | | |
| Sample | cfm | MD | MD | Avg. MD | mg |
| Example 1 | 311.4 | 5.66 | 7.19 | 5.435 | 2121.92 |

Samples of the TR 407/GL730 resin impregnated media described above were electret charged according to the teachings of US Pat. No. 6,365,088B1 to Knight et.al The filtration properties were then measured using a sodium chloride challenge aerosol having a mean particle size of 0.3 microns. The performance of the media as a filter is measured as the percent penetration (% P) for the NaCI particles through the media at a flowrate of 32 L min⁻¹ (face velocity of 5.3 cm s⁻¹). The non-electret charged resin impregnated media had a filter penetration of 95.9%±1.9 %, after charging at +20 kV the resin impregnated media had a filter penetration of 47.6%±1.9%. The represents a greater than 50% decrease in the number of NaCl particles that are able to penetrate through the filter medium. Notably, the nonwoven base sheet prior to impregnation as described above, and following electret charging has a filter penetration of ca. 48%. Thus, the resin impregnated nonwoven has equivalent filtration properties compared to the nonwoven basesheet with the added benefit of being rigidified to enable it to be pleated without the need for any support structure.

### Example 2

A binder composition with 20% AC 3001+80% GL 730 was applied to a 3.25 osy high loft media, prepared in accordance with U.S. Pat. No. 6,169,045, using dip and squeeze application. The binder add-on was approximately 50% by weight. The media has the following physical properties shown in TABLE 2.

TABLE 2

| | Air | Gurley Stiffness | | | |
|---|---|---|---|---|---|
| | Permeability | Left | Right | | |
| Sample | cfm | MD | MD | Avg. MD | mg |
| Example 2 | 289.6 | 4.76 | 4.34 | 4.55 | 1901.43 |

Samples of the AC 3001/GL 730 impregnated media were electret charged as described in Example 1. Similarly, the filtration performance was evaluated as described in Example 1. The filter penetration of non-electret charged AC 3001/GL 730 media was 96.1%±1.2%, following electret charging the filter penetration was 41.3%±3.0%. This represents a 57% decrease in the penetration of 0.3 micron NaCI particles passing through the filter medium.

The nonwoven web of the present invention can be used in a variety of different applications, including, for example, as a filter medium, as a mop material and as a wipe, among other uses. In addition, the nonwoven web can be used in any application where nonwoven webs have been previously used to trap dirt and other debris.

While the invention has been described in detail with respect to specific embodiments thereof, and particularly by the example described herein, it will be apparent to those skilled in the art that various alterations, modifications and other changes may be made without departing from the spirit and scope of the present invention. It is therefore intended that all such modifications, alterations and other changes be encompassed by the claims.

1. An electret nonwoven web comprising
a. a continuous fiber nonwoven web;
b. a binder composition;
wherein the binder composition is applied to the continuous fiber nonwoven web, the binder composition is cured to form a nonwoven web/binder composite, the composite is electret charged.

2. The electret nonwoven web of claim 1, wherein the continuous fiber nonwoven web comprises a spunbond fiber nonwoven web.

3. The electret nonwoven web of claim 2, wherein the nonwoven web comprises monocomponent fibers, multicomponent fibers and/or multiconstituent fibers.

4. The electret nonwoven web of claim 3, wherein the nonwoven web comprises multicomponent fibers.

5. The electret nonwoven web of claim 4, wherein the multicomponent fibers comprise polypropylene as a first component and a polyethylene as a second component.

6. The electret nonwoven web of claim 1, wherein the binder composition is impregnated into the nonwoven web.

7. The electret nonwoven web of claim 6, wherein the binder composition comprises an acrylic resin.

8. The electret nonwoven web of claim 6, wherein the binder add-on is between 10% and 70% based on the weight of the binder and nonwoven web.

9. The electret nonwoven web of claim 8, wherein the binder add-on is between 25 to 60% by weight.

10. The electret nonwoven web of claim 4, wherein the binder composition is impregnated into interstitial spaces or void space of the nonwoven web, and the binder add-on is in the range of 25% to 60% by weight, based on the weight of the binder and nonwoven web.

11. The electret nonwoven web of claim 1, wherein the binder composition comprises a resin which reinforces the nonwoven web.

12. A filter material having a self-supporting pleat comprising an electret nonwoven web wherein the electret nonwoven web comprises
a. a continuous fiber nonwoven web;
b. a binder composition;
wherein the binder composition is applied to the continuous fiber nonwoven web, the binder composition is cured to form a nonwoven web/binder composite, the composite is electret charged and pleated.

13. The filter material of claim 12, wherein the continuous fiber nonwoven web comprises a spunbond fiber nonwoven web.

14. The filter material of claim 13, wherein the nonwoven web comprises monocomponent fibers, multicomponent fibers and/or multiconstituent fibers.

15. The filter material of claim 14, wherein the nonwoven web comprises multicomponent fibers.

16. The filter material of claim 15, wherein the multicomponent fibers comprise polypropylene as a first component and a polyethylene as a second component.

17. The filter material of claim 12, wherein the binder composition is impregnated into the nonwoven web.

18. The filter material of claim 17, wherein the binder composition comprises an acrylic resin.

19. The filter material of claim 17, wherein the resin add-on is between 10% and 70% based on the weight of the binder and nonwoven web.

20. The filter material of claim 19, wherein the binder composition add-on is between 25 to 60% by weight.

21. The filter material of claim 15, wherein the binder composition is impregnated into interstitial spaces or void space of the nonwoven web, and the binder add-on is in the range of 25% to 60% by weight, based on the weight of the binder and nonwoven web.

22. The filter material of claim 12, wherein the binder composition comprises a resin which reinforces the nonwoven web.

23. The filter material of claim 12, wherein the composite exhibits a yield stress at strains of less than 10% in bending mode such that the bent or folded composite exhibit little or no plastic recovery.

24. A process of forming an electret charged nonwoven web comprising
a. providing a nonwoven web of continuous fibers;
b. applying a binder composition to the nonwoven web;
c. curing the binder composition to form a nonwoven/binder composite material;
d. electret charging the composite.

25. The process of claim 24, wherein the binder composition is impregnated into the nonwoven web.

26. A process of forming a filter material with a self-supporting pleat from a nonwoven comprising
a. providing a nonwoven web of continuous fibers;
b. applying a binder composition to the nonwoven web;
c. curing the binder composition to form a nonwoven/binder composite;
d. electret charging the composite to form an electret charged composite; and
e. pleating the electret charged composite.

27. The process of claim 26, wherein the binder composition is impregnated into the nonwoven web.
